(19) United States
(12) Patent Application Publication
(10) Pub. No.: US 2008/0284127 A1
(43) Pub. Date: Nov. 20, 2008

(54) BICYCLE WHEEL SECURING STRUCTURE

(75) Inventor: Etsuyoshi WATARAI, Osaka (JP)

Correspondence Address: GLOBAL IP COUNSELORS, LLP, 1233 20TH STREET, NW, SUITE 700, WASHINGTON, DC, 20036-2680, US

(73) Assignee: SHIMANO INC., Osaka (JP)

(21) Appl. No.: 11/750,679

(22) Filed: May 18, 2007

(51) Int. Cl. B62K 21/00

(52) U.S. Cl. 280/279

(57) ABSTRACT

A bicycle wheel securing structure includes a shaft member, a head member, and a lever member. The shaft member has a first end portion, a second end portion and a central portion disposed between the first and second end portions with a center axis extending between the first and second end portions. The head member is disposed on the second end portion of the shaft member. The lever member is operatively mounted to move the shaft member in an axial direction relative to the head member in response to movement of the lever member. The central portion of the shaft member has a radial thickness smaller than the first and second end portions.

### BACKGROUND OF THE INVENTION

1. Field of the Invention

This invention generally relates to a bicycle wheel securing structure. More specifically, the present invention relates to a bicycle wheel securing structure, which utilizes a shaft member having an area of reduced thickness.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned is the bicycle hub attachment mechanism.

In the past various bicycle parts have been attached using nut and bolt arrangements. However, while certain bicycle parts are designed to be permanently attached to the bicycle, other bicycle parts such as bicycle wheels need to be loosened and removed relatively often. For example, bicycle wheels need to be removed from the frame whenever there is a flat tire. Moreover, bicycle wheels often need to be removed in order to transport a bicycle in an automobile.

Due to the need to remove and reinstall bicycle wheels, bicycle wheel hubs have been provided with wheel securing mechanisms in order to facilitate easier removal and reinstallation of the wheels. A typical wheel securing device includes a skewer with a threaded end having a wheel securing member mounted at the other end. The wheel securing member includes a base with a lever and a cam structure. A nut is detachably threaded onto the threaded end of the skewer after the skewer is inserted through the hub body. The fork flanges of the frame are arranged adjacent the base of the wheel securing member and the hub body and between the nut and the hub body, respectively. Thus, the hub can be attached to the frame by clamping the fork flanges using the wheel securing lever. While these typical wheel securing mechanisms generally work well, a tighter connection between the hub and frame has been in demand for some riders.

Thus, bicycle hubs have been designed with an axle that threadedly attaches directly to the bicycle frame. With this type of hub, a knob is provided on the end of the hub axle opposite the threaded end. The knob is used to rotate the axle during installation to threadedly attach one end of the axle to the frame and to clamp one fork flange between the knob and the hub. With this type of hub, a tighter connection between the hub and the frame is possible as compared to typical wheel securing hubs. However, it can be difficult for some individuals to tighten such a knob. Specifically, with this type of hub, the tightness of the connection between the hub and the frame at least partially depends on the individual installing the hub (i.e., the strength of the individual). Individuals that have difficulty tightening the knob to the desired tightness level may need a tool in order to achieve the desired level of tightness. In any case, while these hubs provide a very tight connection, these types of hubs can be relatively heavier than desired by some riders.

In view of the above, it will be apparent to those skilled in the art from this disclosure that there exists a need for an improved bicycle wheel securing structure. This invention addresses this need in the art as well as other needs, which will become apparent to those skilled in the art from this disclosure.

### SUMMARY OF THE INVENTION

One object of the present invention is to provide a bicycle wheel securing structure, which provides a tight connection, yet is relatively easy to tighten and is relatively lightweight.

Another object of the present invention is to provide a bicycle wheel securing structure, which is relatively simple and inexpensive to manufacture and/or assemble.

The foregoing objects can basically be attained by providing a bicycle wheel securing structure, which includes a shaft member, a head member, and a lever member. The shaft member has a first end portion, a second end portion and a central portion disposed between the first and second end portions with a center axis extending between the first and second end portions. The head member is disposed on the second end portion of the shaft member. The lever member is operatively mounted to move the shaft member in an axial direction relative to the head member in response to movement of the lever member. The central portion of the shaft member has a radial thickness smaller than the first and second end portions.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a bicycle with a rear bicycle hub coupled thereto in accordance with a first embodiment of the present invention;

FIG. 2 is an enlarged, exploded perspective view of a portion of the frame and the rear hub illustrated in FIG. 1;

FIG. 3 is an exploded, perspective view of the wheel securing axle of the rear hub illustrated in FIG. 2;

FIG. 4 is an enlarged, partial cross-sectional view of a portion of the frame and the rear hub illustrated in FIG. 2, with the wheel securing axle in a first, partially installed position;

FIG. 5 is an enlarged, end elevational view of the portion of the frame and the rear hub illustrated in FIG. 4, illustrating rotation of the wheel securing axle from the first, partially installed position;

FIG. 6 is an enlarged, partial cross-sectional view of a portion of the frame and the rear hub illustrated in FIG. 2, with the wheel securing axle in a second, partially installed position (i.e. during rotation as illustrated in FIG. 5)

FIG. 7 is an enlarged, partial cross-sectional view of a portion of the frame and the rear hub illustrated in FIG. 2, with the wheel securing axle in a third, partially installed position (i.e. after rotation as illustrated in FIGS. 5 and 6) but prior to clamping the frame using the wheel securing lever;

FIG. 8 is an enlarged, partial cross-sectional view of a portion of the frame and the rear hub illustrated in FIG. 2, with the wheel securing axle in a fully installed position after clamping the frame using the wheel securing lever;

FIG. 9 is a longitudinal elevational view of the inner axle assembly (i.e., the inner axle, the head member and lever member) of the wheel securing axle illustrated in FIGS. 2-8;

FIG. 10 is a longitudinal elevational view of the outer axle of the wheel securing axle illustrated in FIGS. 2-8;

FIG. 11 is an enlarged perspective view of the inner axle of the inner axle assembly illustrated in FIG. 9;

FIG. 12 is an enlarged, outer end elevational view of the adjustment member of the wheel securing axle illustrated in FIGS. 2-8;

FIG. 13 is a side elevational view of the adjustment member illustrated in FIG. 12;

FIG. 14 is an inner end elevational view of the adjustment member illustrated in FIGS. 12 and 13;

FIG. 15 is an enlarged, exploded perspective view of a portion of the frame illustrated in FIG. 1 and a rear hub in accordance with a second embodiment of the present invention;

FIG. 16 is an exploded, perspective view of the wheel securing axle of the rear hub illustrated in FIG. 15;

FIG. 17 is an enlarged, partial cross-sectional view of the portion of the frame and the rear hub illustrated in FIG. 15, with the wheel securing axle in a first, partially installed position;

FIG. 18 is an enlarged, end elevational view of the portion of the frame and the rear hub illustrated in FIG. 17, illustrating rotation of the wheel securing axle from the first, partially installed position;

FIG. 19 is an enlarged, partial cross-sectional view of a portion of the frame and the rear hub illustrated in FIG. 15, with the wheel securing axle in a second, partially installed position (i.e. during rotation as illustrated in FIG. 18)

FIG. 20 is an enlarged, partial cross-sectional view of a portion of the frame and the rear hub illustrated in FIG. 15, with the wheel securing axle in a third, partially installed position (i.e. after rotation as illustrated in FIGS. 18 and 19) but prior to clamping the frame using the wheel securing lever;

FIG. 21 is an enlarged, partial cross-sectional view of a portion of the frame and the rear hub illustrated in FIG. 15, with the wheel securing axle in a fully installed position after clamping the frame using the wheel securing lever;

FIG. 22 is a longitudinal elevational view of the inner axle assembly (i.e., the inner axle, the head member and lever member) of the wheel securing axle illustrated in FIGS. 15-21;

FIG. 23 is a longitudinal elevational view of the outer axle of the wheel securing axle illustrated in FIGS. 15-21;

FIG. 24 is an enlarged, exploded perspective view of a portion of a frame and a rear hub in accordance with a third embodiment of the present invention;

FIG. 25 is an exploded, perspective view of part of the wheel securing axle of the rear hub illustrated in FIG. 24.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

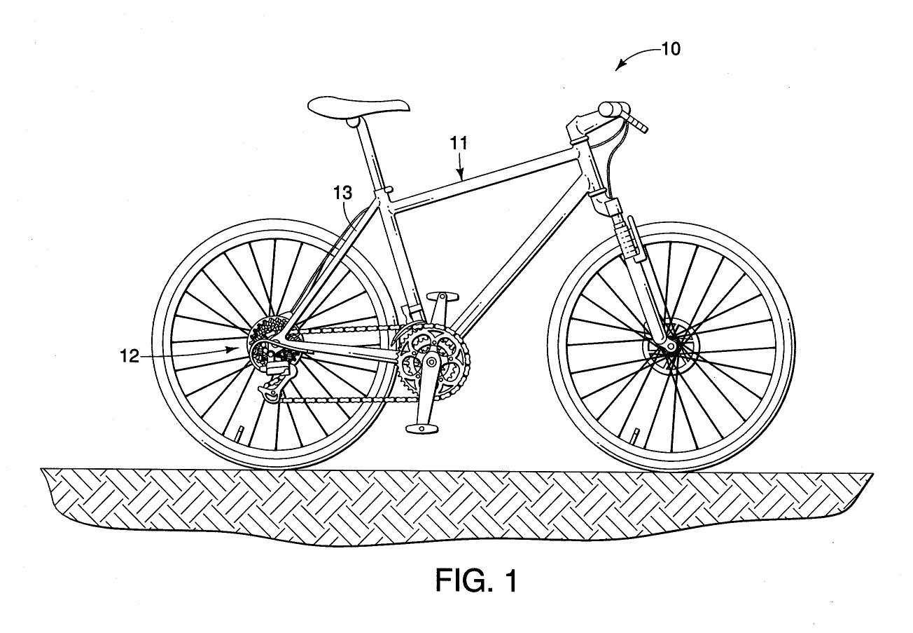

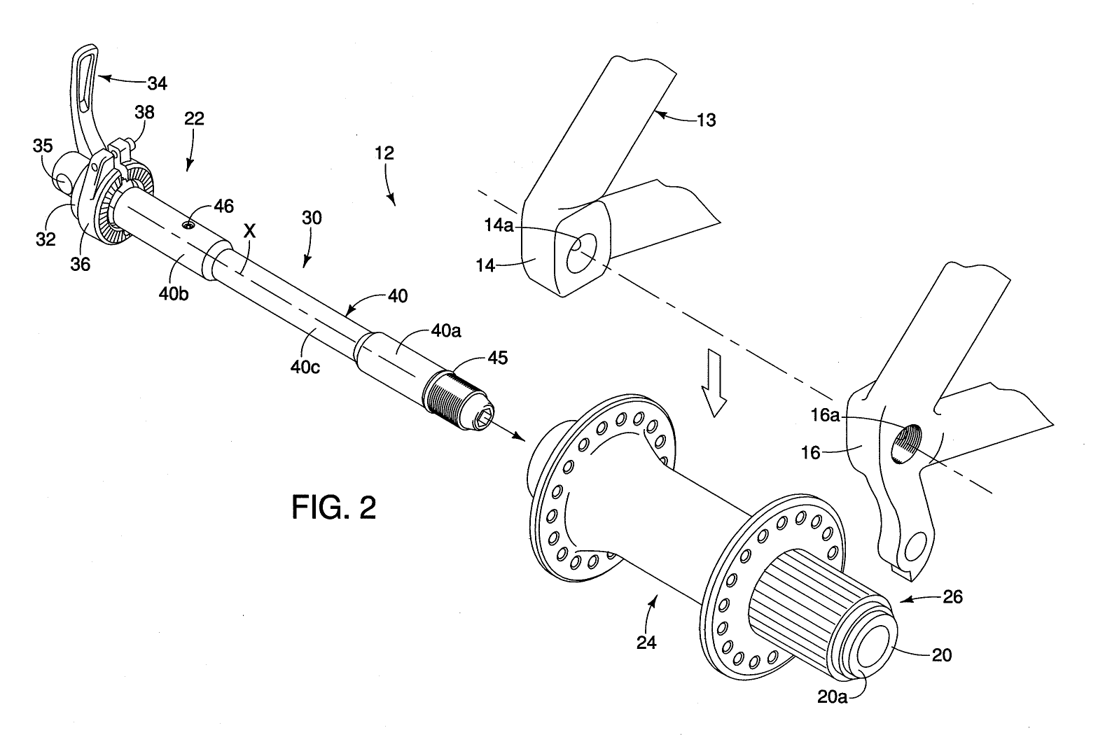

Referring initially to FIGS. 1 and 2, a bicycle 10 is illustrated, which has a rear bicycle hub 12 coupled thereto in accordance with a first embodiment of the present invention. The rear hub 12 is attached the frame 11 of the bicycle 10 using a bicycle wheel securing structure or axle 22 in accordance with the present invention. Specifically, the frame 11 includes a rear fork or triangle 13 with a pair of hub mounting flanges 14 and 16 formed at the free ends thereof. Preferably, one end of the wheel securing axle 22 is directly threadedly attached to the mounting flange 16, while the other end has a wheel securing mechanism that is used to securely attach the wheel securing axle 22 to the other mounting flange 14.

The bicycle 10 is conventional, except for the rear hub 12 having the wheel securing axle 22. Accordingly, the bicycle 10 and its various components will not be discussed and/or illustrated in detail herein, except as related to the rear hub 12 and the wheel securing axle 22 of the present invention. Moreover, it will be apparent to those skilled in the bicycle art from this disclosure that various modifications can be made to the bicycle 10 and its components without departing from the present invention.

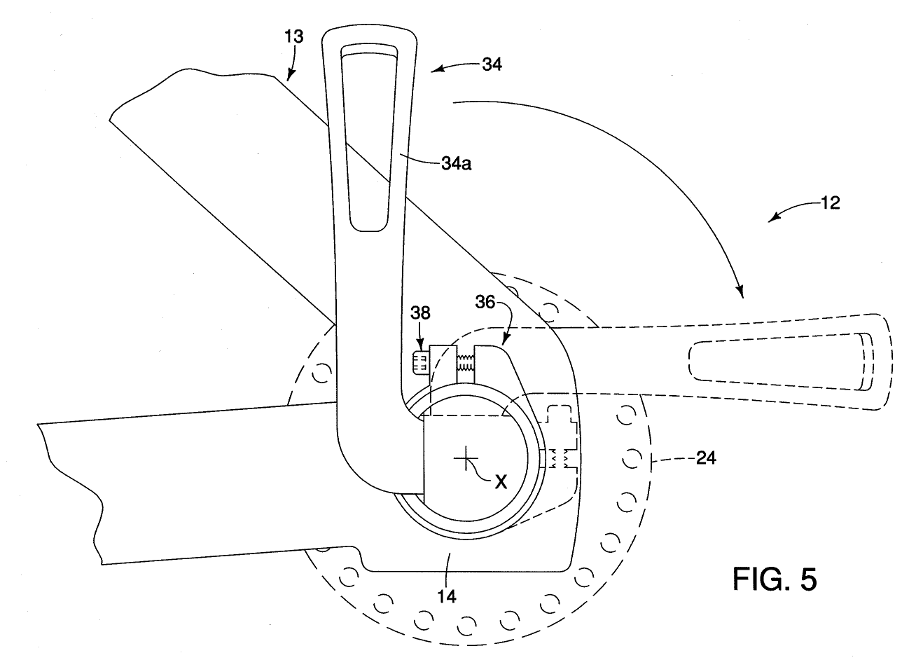

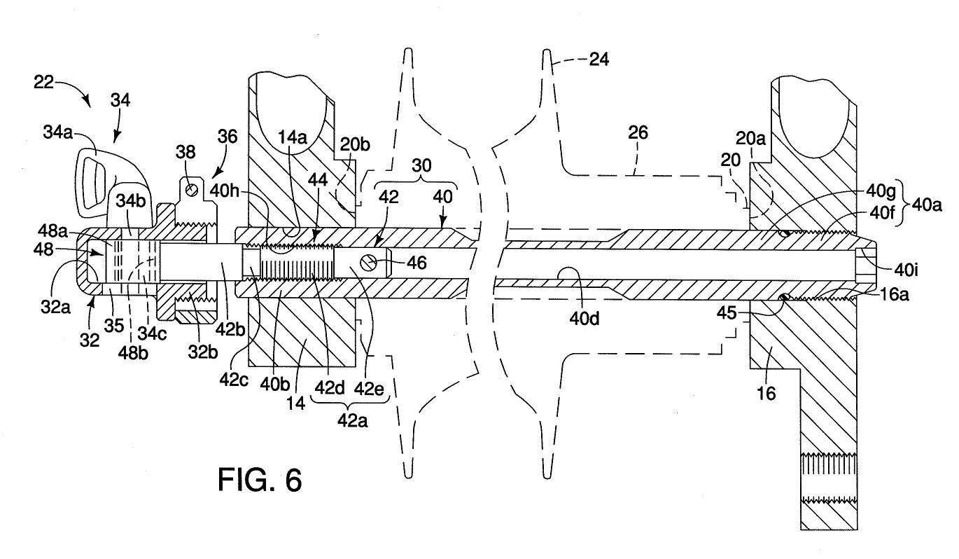

Referring to FIGS. 2-8, the rear bicycle hub 12 includes a main hub axle 20, the wheel securing axle 22, a hub assembly 24 and a freewheel 26. The rear hub 12 is conventional, except for the wheel securing axle 22. Accordingly, the rear hub 12 will not be discussed and/or illustrated in detail herein, except as related to the wheel securing axle 22 of the present invention. A hub shell (outline shown in broken lines) of the hub assembly 24 and the free wheel 26 are rotatably supported on the main hub axle 20 of the rear hub 12 via a bearing assembly and/or other conventional parts in a conventional manner. The wheel securing axle 22 extends through the main hub axle 20. Thus, forward rotation of rear sprockets mounted on the free wheel 26 transmits torque to the hub assembly 24. The hub assembly 24 is coupled to the rear rim via a plurality of spokes in a conventional manner to transmit the forward rotation of the hub assembly 24 to the rear rim (tire). The main hub axle 20, the hub assembly 22 and the freewheel 26 constitute parts of a tubular hub structure that is mounted between the mounting flanges 14 and 16. The main hub axle 20 includes first and second ends or end parts with first and second oppositely facing axial surfaces 20a and 20b that contact the mounting flanges 16 and 14, respectively. The overall axial length of the tubular hub structure is measured between the first and second oppositely facing axial surfaces 20a and 20b.

While the wheel securing axle 22 of the present invention is particularly suited for use with a rear hub such as the rear hub 12 disclosed herein, it will be apparent to those skilled in the bicycle art from this disclosure that the wheel securing axle 22 of the present invention could be used in other types of rear hubs (e.g. internally geared hubs) as well as in various front hubs.

Referring to FIGS. 2-14, the bicycle wheel securing axle 22 basically includes a shaft member 30, a head member 32, a lever member 34 and an adjustment member 36. The shaft member 30 has one end directly threadedly attached to the mounting flange 16, and an opposite end supporting the head member 32. The lever member 34 is operatively mounted between the shaft member 30 and the head member 32 to move the shaft member 30 in an axial direction relative to the head member 32 in response to movement of the lever member 34 from a release position to a wheel securing position. The adjustment member 36 is axially adjustably coupled to the head member 32 such that an axial position of the adjustment member 36 can be adjusted relative to the shaft member 30 and the head member 32, as explained below in more detail.

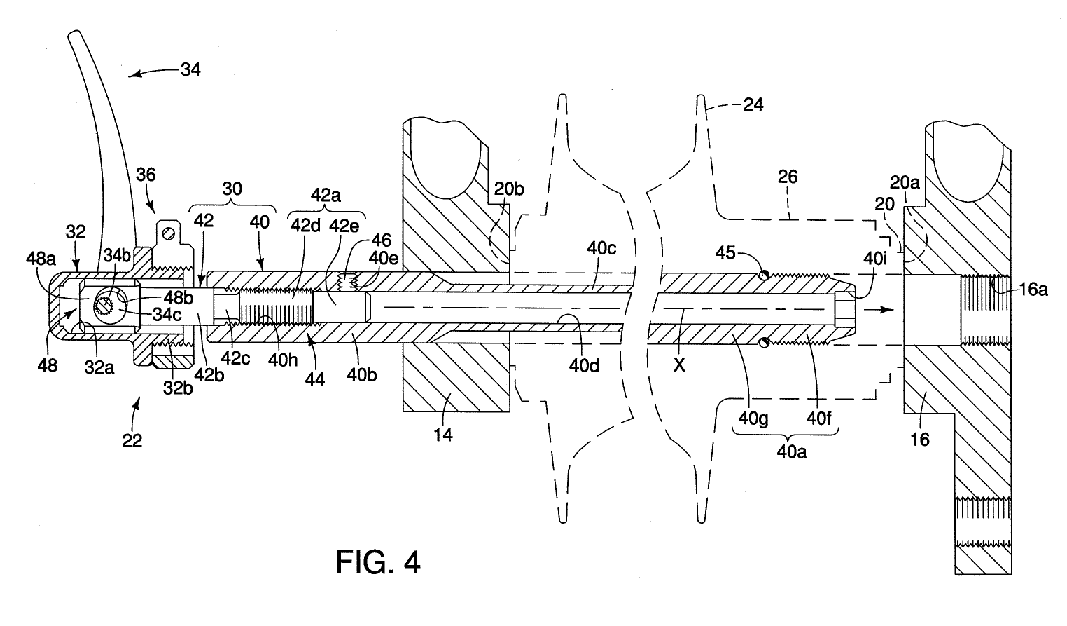

The shaft member 30 basically includes an outer axle (outer shaft) 40 and an inner axle (inner shaft) 42 releasably attached within the outer axle 40 in an installed position, as seen in FIGS. 4 and 6-8. The outer axle 40 and the inner axle 42 are preferably releasably attached together via a threaded connection 44 to releasably prevent axial removal of the inner axle 42 from the outer axle 40 when the inner axle 42 is in the installed position. The outer and inner axles 40 and 42 can be selectively prevented from rotating relative to each other so that they move together, as explained below. The shaft member 30 has a longitudinal center axis X extending between opposite ends, as seen in FIGS. 2-5. A direction parallel to the center axis X is an axial/longitudinal direction, while a direction perpendicular to the center axis X is a transverse direction.

Referring to FIGS. 2-4, 6-8 and 10, the outer axle 40 basically includes a first (tubular) end portion 40a, a second (tubular) end portion 40b, an outer central (tubular) portion 40c, an internal bore 40d and a transverse threaded bore 40e. The internal bore 40d preferably extends axially completely through the outer axle 40 such that the outer axle 40 is preferably a tubular member. The outer central portion 40c is axially disposed between the first and second end portions 40a and 40b. The transverse threaded bore 40e extends between the external surface of the second end portion 40b and the internal bore 40d. The outer axle 40 preferably has a circular shape as viewed along the longitudinal center axis X.

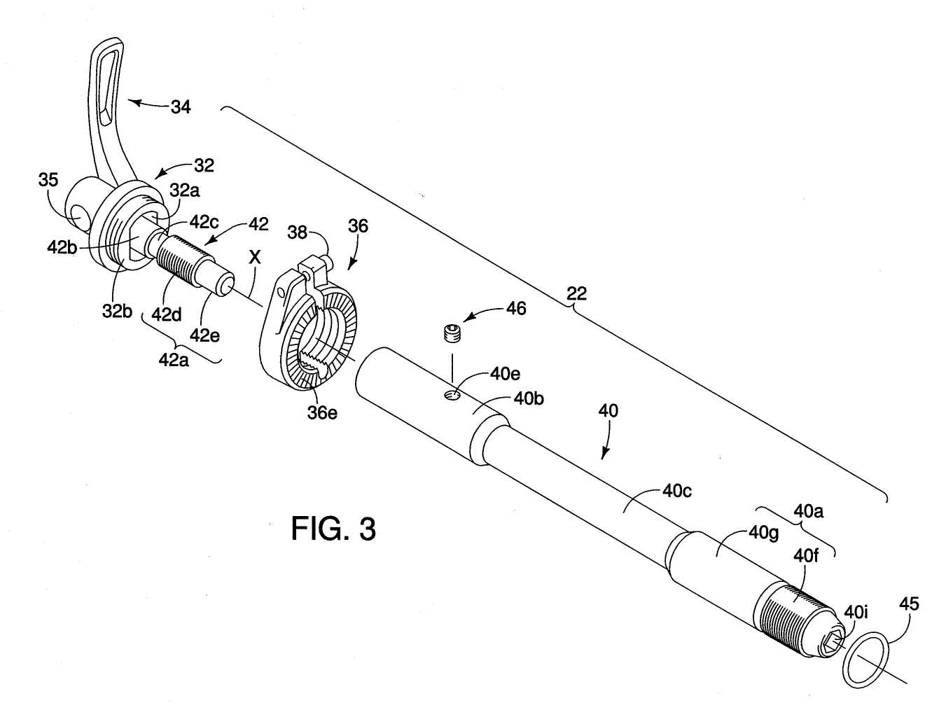

The first end portion 40a has a threaded end section 40f that is preferably directly threadedly attached to the mounting flange 16, and an unthreaded section 40g axially disposed between the threaded section 40f and the outer central portion 40c. The unthreaded section 40g is preferably partially disposed within the mounting flange 16. The second end portion 40b is attached to the mounting flange 14 using the head member 32, the lever member 34 and the adjustment member 36, as explained below. The second end portion 40b is partially received within the mounting flange 14. The outer axle 40 preferably has a circular external shape, as viewed along the center axis X, as best understood from FIG. 3.

The outer axle 40 is preferably constructed of a lightweight rigid material such as a metallic material utilizing conventional manufacturing techniques such as casting and/or machining. In this embodiment, the first end portion 40a, the second end portion 40b and the central portion 40c of the outer axle 40 are preferably constructed as a one-piece, unitary member. An O-ring 45 is preferably mounted in a mating groove of the first end portion 40a between the threaded end section 40f and the unthreaded section 40g. The O-ring 45 is preferably constructed of an elastomeric material such as rubber, and engages the mounting flange 16 to prevent unintentional rotation of the outer axle 40 relative to the mounting flange 16.

The outer central portion 40c preferably has a radial thickness smaller than the first and second end portions 40a and 40b. Specifically, first end portion 40a has a first radial thickness T₁, the second end portion 40b has a second radial thickness T₂, and the central portion 40c has a radial thickness T₃ that is preferably less than one-half of the radial thicknesses T₁ and T₂ of the first end portions 40a and 40b. In other words, the radial thicknesses T₁ and T₂ are preferably more than twice the radial thickness T₃. The radial thickness T₁ is measured about the (first) unthreaded section 40g of the first end portion 40a, while the radial thickness T₂ is measured about a similar unthreaded section of the second end portion 40b. The first and second radial thicknesses T₁ and T₂ of the first and second end portions 40a and 40b are preferably maximum radial thicknesses of the first and second end portions 40a and 40b, respectively. Preferably, the radial thicknesses T₁ and T₂ of the first and second end portions 40a and 40b are equal. The radial thickness T₃ is preferably a minimum radial thickness of the central portion 40c.

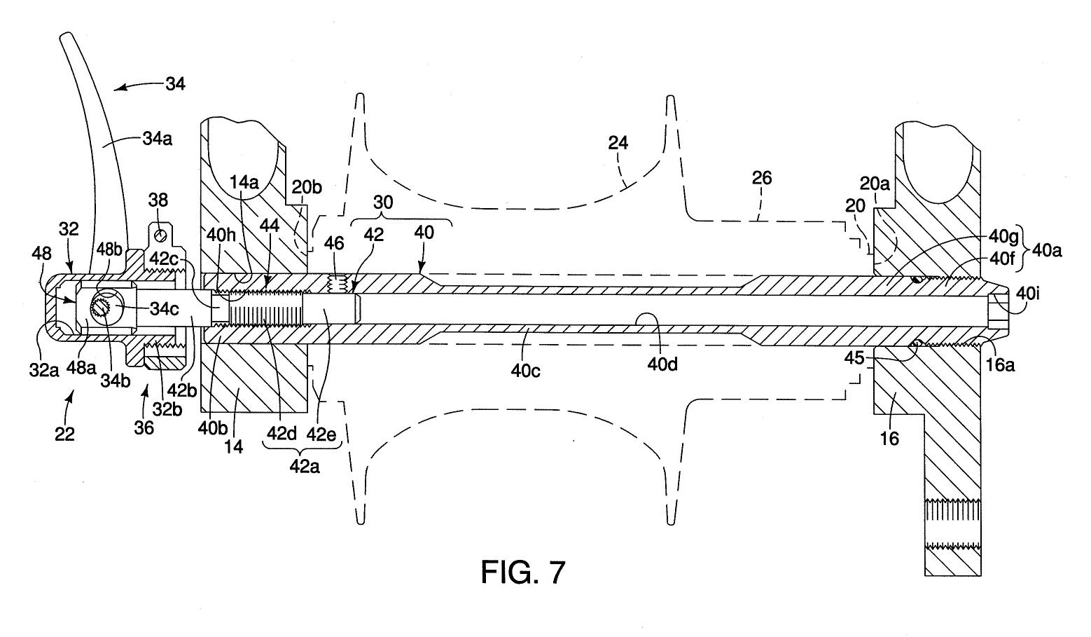

The outer central portion 40c is preferably recessed externally and has conical transition areas at opposite ends thereof. The outer central portion 40c has an axial length L that is at least 25% of an overall axial length of the shaft member 30 (i.e., the assembled outer and inner axles 40 and 42), preferably at least 33% of the overall axial length of the shaft member 30. More specifically, the axial length L is preferably about 40% of an overall axial length of the outer axle 40. The axial length L is preferably at least 50% of a maximum axial length of the tubular hub structure (preferably 60-65%) as measured between the oppositely facing axial surfaces 20a and 20b. As mentioned above, the main hub axle 20, the hub assembly 22 and the freewheel 26 constitute parts of the tubular hub structure that is mounted between the mounting flanges 14 and 16 in accordance with the present invention. Due to the above configuration, the outer axle 40 has a minimum external diameter measured along the outer central portion 40c that is 70-75% of a maximum external diameter measured along the first and second end portions 40a and 40b. Thus, the shaft member 30 has the same external diameters in the areas between the mounting flanges as the outer axle 40, i.e., except for the portion of the inner axle 42 extending out of the internal bore 40d of the outer axle 40. These relationships can be understood from FIGS. 7, 8 and 10.

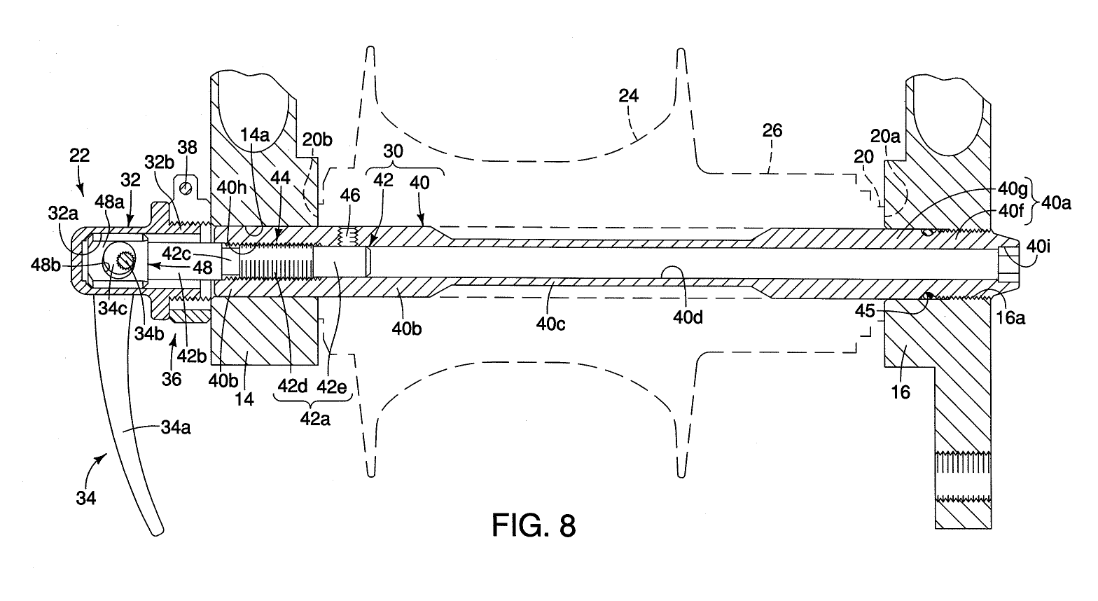

The mounting flange 16 has a through bore 16a that is preferably a closed bore with a continuous annular surface having female threads (i.e., preferably not a slot), which receives the first end portion 40a. In this embodiment, the through bore 16a is partially threaded. The O-ring 45 preferably engages the through bore 16a to prevent undesired rotation of the outer axle 40 relative to the mounting flange 16. The mounting flange 14 has an unthreaded bore 14a that is preferably a closed bore with a continuous annular surface (i.e., preferably not a slot), which receives the second end portion 40b. However, it will be apparent to those skilled in the bicycle art from this disclosure that outer axle 40 could be attached to a flange 14 having an open ended slot if needed and/or desired. The outer axle 40 of the shaft member 30 is preferably dimensioned and tightened to the mounting flange 16 such that the second end portion 40b of the outer axle 40 adjacent the head member 32 does not project beyond an outer axially facing surface of the mounting flange 14, as seen in FIG. 8.

In this embodiment, the internal bore 40d is a through bore with a threaded section 40h arranged at the second end portion 40b of the outer axle 40 and a hexagonal bore 401 arranged at the first end portion 40a. The internal bore 40d is slightly stepped in order to receive the inner axle 42 therein, as best understood from FIGS. 4 and 6-10. The inner axle 42 is threadedly attached to the threaded section 40h of the internal bore 40d. The inner axle 42 extends out of the internal bore 40d at the second end portion 40b. Thus, the inner axle 42 extends from the second end portion 40b of the outer axle 40 when the inner axle 42 is in the installed position. The head member 32 is preferably attached to an end of the inner axle 42 extending out of the internal bore 40d, as explained below. The internal bore 40d preferably has a circular internal shape, as viewed along the center axis X.

A set screw 46 is preferably threadedly mounted in the transverse threaded bore 40e to releasably prevent relative rotation of the inner axle 42 within the internal bore 40d when the inner axle 42 is in the installed position, as explained below. The set screws 46 are arranged to selectively contact an external surface of the inner axle 42 when the set screws 46 are tightened, as shown in FIGS. 4 and 6-8. Specifically, the set screw 46 frictionally prevents rotation of the inner axle 42 relative to the outer axle 40 when tightened against the external surface of the inner axle 42. Thus, the set screw 46 is preferably disposed between the outer axle 40 and the inner axle 42 to releasably prevent relative rotation of the inner axle 42 within the internal bore 40d when the inner axle 42 is in the installed position. The transverse threaded bore 40e extends between an external surface of the outer axle 40 and the internal bore 40d.

Referring to FIGS. 2-4, 6-9 and 11, the inner axle 42 basically includes an inner first end portion 42a, an inner second end portion 42b, an inner central portion 42c and a bracket 48. The first end portion 42a includes a threaded section 42d and a free end section 42e extending axially from the threaded section 42d so as to be aligned with the transverse threaded bore 40e when the inner axle 42 is installed in the outer axle 40. In this embodiment, the free end section 42e of the inner axle 42 includes a smooth outer surface and the set screw 46 releasably frictionally contacts the smooth outer surface to prevent relative rotation between the outer axle 40 and the inner axle 42 in an area located axially closer to the first end portion 40a than the threaded connection 44 and the head member 32. The threaded section 42d is threadedly attached to the threaded section 40h of the internal bore 40d. The threaded section 42d and the threaded section 40h constitute parts of the threaded connection 44 when coupled together.

The second end portion 42b is partially received in an unthreaded section of the through bore 40d such that the second end portion 42b extends out of the internal bore 40d and supports the head member 32 and the lever member 34. Specifically, the second end portion 42b of the inner axle 42 has the bracket 48 attached thereto, which supports the head member 32 and the lever member 34. The central portion 42c is axially disposed between the threaded section 42d and the second end portion 42b. The central portion 42c and the free end section 42e preferably have smaller diameters and smaller radial thicknesses than the threaded section 42d and the second end portion 42b. The inner axle 42 preferably has a circular shape as viewed along the center axis X, except for the bracket 48 arranged on the free end of the second end portion 42b, which extends out of the internal bore 40d, as best understood from FIGS. 3, 4 and 6.

The inner axle 42 is preferably constructed of a lightweight rigid material such as a metallic material utilizing conventional manufacturing techniques such as casting and/or machining. In this embodiment, the first end portion 42a, the second end portion 42b and the central portion 42c are preferably integrally formed together as a one-piece, unitary member. The bracket 48 can be integrally formed with the second end portion 42b, or the bracket 48 can be constructed as a separate member that is fixed to the inner axle 42 (e.g. by welding or the like).

The bracket 48 is received within the head member 32 and is coupled to the lever member 34. The bracket 48 preferably has a block configuration with a support portion 48a having an eccentric cam opening 48b formed therein. The eccentric cam opening 48b extends between two flat sides 48c, while a pair of curved sides 48d connect the flat sides 48c. Part of the lever member 34 is received in the eccentric cam opening 48b. The bracket cooperates with the lever member to move the inner axle 42, and thus, the shaft 30 axially relative to the head member 32 in response to rotation of the lever member 34.

In this embodiment, the first end portion 40a of the outer axle 40 constitutes a first end portion of the shaft member 30, while the central portion 40c of the outer axle 40 constitutes a central portion of the shaft member 30. On the other hand, the second end portion 40b of the outer axle 40 and the inner axle 42 mounted therein constitute parts of the second end portion of the shaft member 30. The first and second end portions of the shaft member 30 axially overlap the first and second oppositely facing axial surfaces 20a and 20b to radially support the first and second end parts of the main hub axle 20 (i.e., to radially support the tubular hub structure).

Referring to FIGS. 2-8, the lever member 34 basically includes an operating lever portion 34a, a pivot pin portion 34b and a cam portion 34c. The lever member 34 is operatively mounted to move the inner axle 42 in an axial direction relative to the head member 32 in response to movement of the lever member 34. The cam portion 34c rotates with the operating lever portion 34a within the eccentric cam opening 48b of the bracket 48. The outer surface of the cam portion 34c cooperates with the eccentric cam opening 48b during rotation of the operating lever portion 34a to move the head member 32 axially closer to the threaded connection 44 when the operating lever portion 34a is rotated from the release position to the fixing position, as seen in FIGS. 7 and 8, respectively.

The pivot pin portion 34b is rotatably supported by the head member 32 in one or more holes in a relatively conventional manner. Specifically, an enlarged cap member 35 is mounted on the tip of the pivot pin portion 34b to retain the pivot pin portion 34b and the cam portion 34c of the lever member 34 within the head member 32 and the bracket 48. The cap member 35 is mounted in an enlarged opening of the head member 32, while the pivot pin portion 34b extends through an opposed opening of the head member 32. In any case, the bracket 48 cooperates with the lever member 34 to move the inner axle 42 of the shaft member 30 in an axial direction relative to the head member 32 in response to movement of the lever member 34 from the release position shown in FIG. 7 to the fixing position shown in FIG. 8. The bracket 48, the head member 32 and the lever member 34 function (cooperate with each other) in a relatively conventional manner, and thus, will not be explained and/or illustrated in further detail herein.

Referring still to FIGS. 2-8, the head member 32 is basically a cup-shaped member having an internal recess 32a and a threaded section 32b. The bracket 48 of the inner axle 42 is non-rotatably received in the recess 32a. In other words, the recess 32a preferably has a shape that mates with the block-shaped support portion 48a of the bracket 48 to prevent relative rotation therebetween. Also, the cam portion 34c is received in the recess 32b within the bracket 48. The pivot pin portion 34b, extending from the operating lever portion 34a, extends in a transverse direction through the head member 32 and through the support portion 48a of the bracket 48, which is disposed within the recess 32a. The lever member 34 is preferably spaced axially outwardly from the threaded section 32b along the center axis X.

The threaded section 32b preferably has a tubular configuration with external (male) threads. The adjustment member 36 is threaded onto the externally threaded section 32b. Preferably, the externally threaded section 32b has an axial length that is the same as or slightly smaller than an axial length of the adjustment member 36 so that the adjustment member 36 will contact the mounting flange 14 in a fully assembled state, as shown in FIG. 8. In other words, the threaded section 32b alone does not contact the mounting flange 14. Thus, the adjustment member 36 is axially adjustably coupled to the head member 32 such that a final position of the lever member 34 in a rotational direction can be adjusted when a bicycle wheel is fully secured to a bicycle frame 11.

Referring now to FIGS. 2-8 and 12-14, the adjustment member 36 will now be explained in more detail. The adjustment member 36 is threadedly mounted on the externally threaded section 32b, as mentioned above. Thus, the adjustment member 36 is axially adjustably coupled to the head member 32 by rotating the adjustment member 36 relative to the head member 32. The adjustment member 36 basically has a split ring or C-shaped configuration. The adjustment member 36 basically includes a first free end 36a, a second free end 36b, a curved connecting portion 36c with an internal (female) threaded bore 36d, an axially facing abutment surface 36e, and a tightening element 38. The threaded bore 36d extends axially through the adjustment member 36. The axially facing abutment surface 36e is formed on an end of the adjustment member facing the threaded connection 44. The tightening element 38 is preferably coupled between the first and second ends 36a and 36b to selectively prevent rotation of the adjustment member 36, as explained below.

The adjustment member 36 is preferably constructed of a lightweight rigid material such as a metallic material utilizing conventional manufacturing techniques such as casting and/or machining. The first end 36a, the second end 36b and the connecting portion 36c of the adjustment member 36 are preferably integrally formed together as a one-piece, unitary member. The tightening element 38 is preferably formed as a separate member from the first end 36a, the second end 36b and the connecting portion 36c of the adjustment member 36.

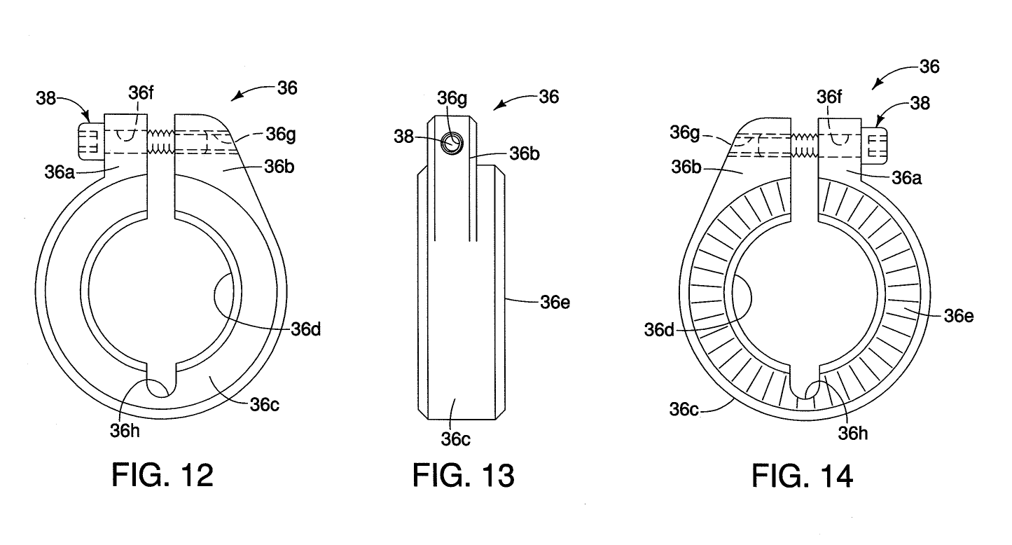

The first end 36a of the adjustment member 36 preferably has an unthreaded through bore 36f that is aligned with a threaded bore 36g of the second end 36b, as best seen in FIGS. 12-14. The tightening element 38 is preferably a threaded bolt or screw with a threaded shaft an enlarged head. The shaft of the tightening element 38 extends through the through bore 36f and into the threaded bore 36g to adjustably attach the first and second free ends 36a and 36b together. The head of the tightening element 38 contacts the first free end 36a of the adjustment member 36.

When the tightening element 38 is tightened (rotated to extend further into the threaded bore 36g), the internal diameter of the threaded bore 36d is reduced. On the other hand, when the tightening element 38 is loosened (rotated in the opposite direction to extend less into the threaded bore 36g), the internal diameter of the threaded bore 36d is increased. The threaded internal bore 36d preferably includes an axially extending notch 36h formed therein to facilitate tightening of the tightening element 38 to reduce the internal diameter of the threaded internal bore 36d.

If the internal diameter of the threaded bore 36d is reduced a predetermined amount by the tightening element 38, friction between the threaded bore 36d and the external threaded section 32b of the head member 32 prevents rotation of the adjustment member 36 relative to the head member 32. On the other hand, if the internal diameter of the threaded bore 36d is increased a predetermined amount by the tightening element 38, friction between the threaded bore 36d and the external threaded section 32b of the head member 32 is negligible such that free rotation of the adjustment member 36 relative to the head member 32 is permitted. In other words, varying degrees of frictional engagement between the adjustment member 36 and the head member 32 can be provided depending on how tight the tightening element 38 is (i.e., how much the tightening element 38 is rotated). Preferably, once the adjustment member 36 is located in the desired position on the head member 32 (i.e., relative to the mounting flange 14), the tightening element 38 is tightened enough to prevent rotation of the adjustment member 36 relative to the head member 32.

Because the axial position of the adjustment member 36 relative to the head member 32 is adjustable, the axial position of the abutment surface 36e of the adjustment member 36 can be adjusted relative to the head member 32. Thus, the axial position of the abutment surface 36e can be adjusted relative to the shaft member 30. The abutment surface 36e is preferably a textured surface configured to frictionally engage the mounting flange 14. The configuration of the textured axially facing abutment surface 36e is illustrated as a plurality of radially extending rigdes/valleys. However, it will be apparent to those skilled in the bicycle art from this disclosure that the abutment surface 36e can have other configurations as needed and/or desired.

Referring now to FIGS. 2-14, assembly and use of the rear hub 12 having the wheel securing axle 22 in accordance with the present invention will now be explained in more detail. Prior to mounting the rear hub 12 having the wheel securing axle 22 to the mounting flanges 14 and 16, the main hub axle 20, the hub assembly 24 and the free wheel 26 are assembled together as a unit in a conventional manner. The wheel securing axle 22 is assembled as a separate unit from the unit including the main hub axle 20, the hub assembly 24 and the free wheel 26 in accordance with the present invention.

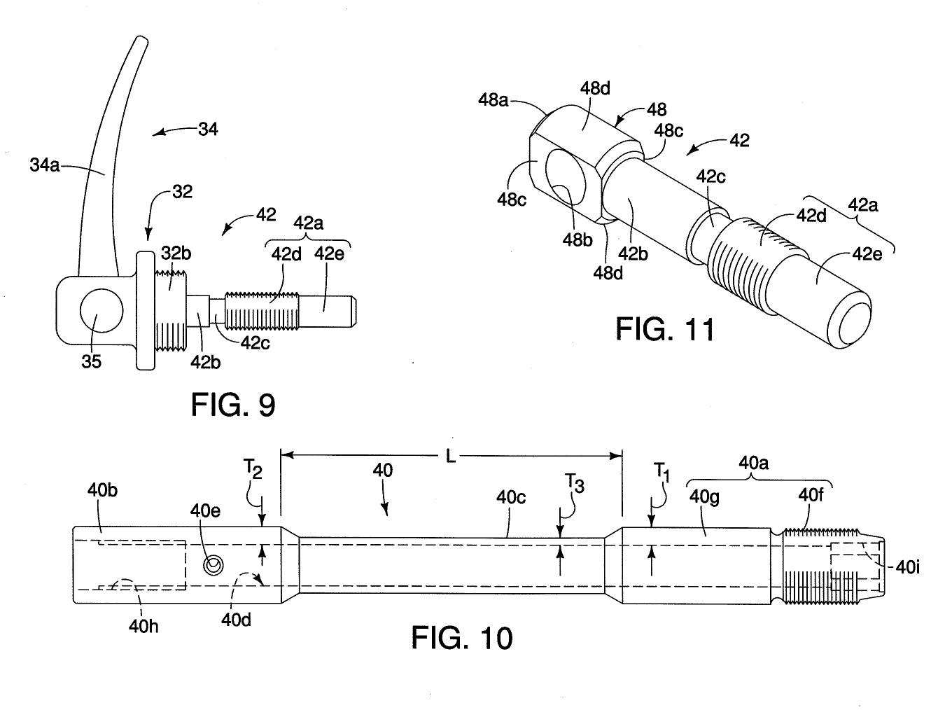

In order to assemble the wheel securing axle 22 as a unit, the wheel securing mechanism (i.e., the head member 32, the lever member 34 and the inner axle 42) is assembled using conventional assembly techniques, as seen in FIGS. 3 and 9. The adjustment member 36 can be threaded onto the head member 32 before or after assembling the wheel securing mechanism (i.e., the head member 32, the lever member 34 and the inner axle 42), as best understood from FIG. 3. The inner axle 42 can be coupled to the outer axle 40 before or after assembling the head member 32, the lever member 34 and the inner axle 42 together. In either case, the inner axle 42 is inserted into the internal bore 40d and threadedly attached to the outer axle 40 such that axial removal of the inner axle 42 is prevented, as best understood from FIGS. 3 and 4. Then the set screw 46 is coupled between the outer axle 40 and the inner axle 42 to prevent rotation of the inner axle 42 relative to the outer axle 40, as best understood from FIGS. 3 and 4.

Once the inner axle assembly and the outer and inner axles 40 and 42 are fully assembled, the unit including the main hub axle 20, the hub assembly 24 and the free wheel 26 can now be attached to the mounting flanges 14 and 16 using the wheel securing axle 22. In order to mount the rear hub 12 to the frame 11, the unit including the main hub axle 20, the hub assembly 24 and the free wheel 26 is positioned between the mounting flanges 14 and 16. The wheel securing axle 22 is then inserted through the hole 14a of the mounting flange 14, through the main hub axle 20, through the hub assembly 24 and the free wheel 26, and threaded into the through bore 16a of the mounting flange 16, as best understood from FIGS. 4-7. Now, the adjustment member 36 is axially adjusted relative to the head member 32 such that moving the lever member 34 from the release position (FIG. 7) to the fixing position (FIG. 8) tightly clamps the mounting flange 14. Once the desired position of the adjustment member 36 is determined, the tightening element 38 can be tightened. By adjusting the axial position of the adjustment member 36, the final position of the lever portion 34a when the lever member 34 is completely in the fixing position can also be adjusted. Thus, a user can adjust the final position of the lever portion 34a as he/she wants, e.g. such that the lever member 34 is not accidentally in the release position by hitting against a foreign object (such as rocks, undulation of the ground or the like) during a bicycle ride.

If the rear wheel needs to be removed, the lever member 34 is moved to the release position, and then the entire wheel securing axle 22 is rotated to detach the shaft 30 from the mounting flange 16. Then the entire wheel securing axle 22 can be axially removed, and the remainder of the rear wheel can be removed from the rear triangle 13 of the bicycle frame 11. The installation procedure above can be repeated to reattach the rear hub 12 to the bicycle frame 11.

The threaded connection 44 disposed between the outer axle 40 and the inner axle 42 forms part of a fixing structure (i.e., adjustment structure or adjustable fixing structure) of the shaft member 30 (disposed between the outer axle 40 and the inner axle 42), which releasably prevents axial removal of the inner axle 42 from the internal bore 40d when the inner axle 42 is in the installed position. The set screw 46 mounted in the transverse threaded hole 40e of the outer axle 40 and the external surface of the inner axle 42 also form part of the fixing structure (i.e., adjustment structure or adjustable fixing structure) of the shaft member 30 (disposed between the outer axle 40 and the inner axle 42), which releasably prevents relative rotation of the inner axle 42 within the internal bore 40d when the inner axle 42 is in the installed position. Optionally, the adjustment member 36 may also be considered part of the adjustment structure or adjustable fixing structure.

### Second Embodiment

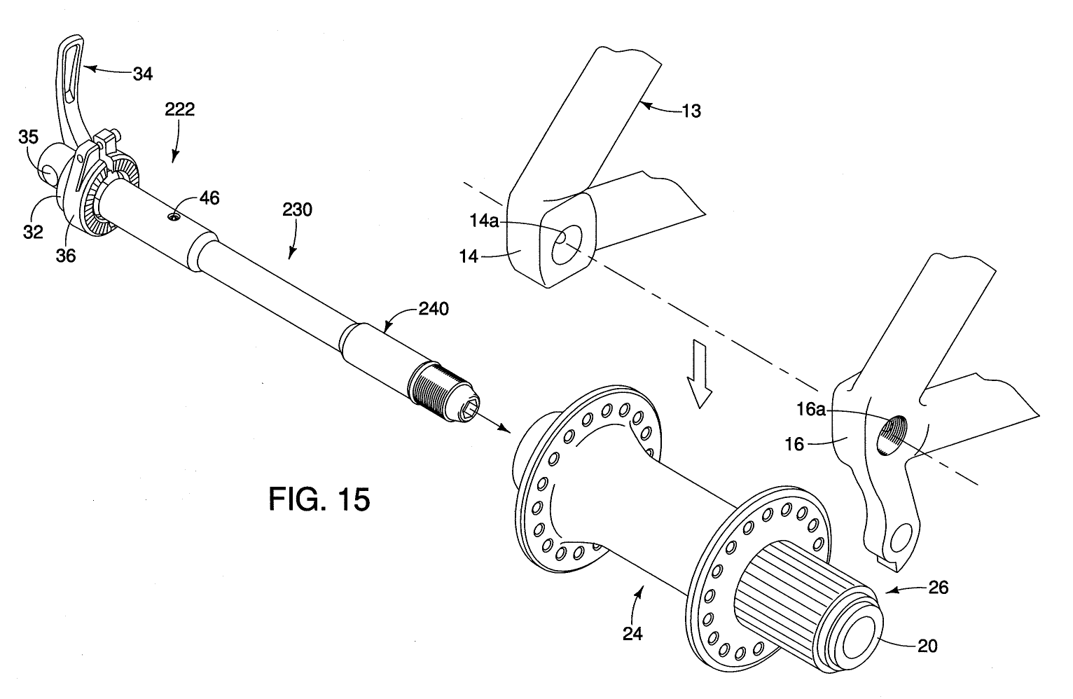

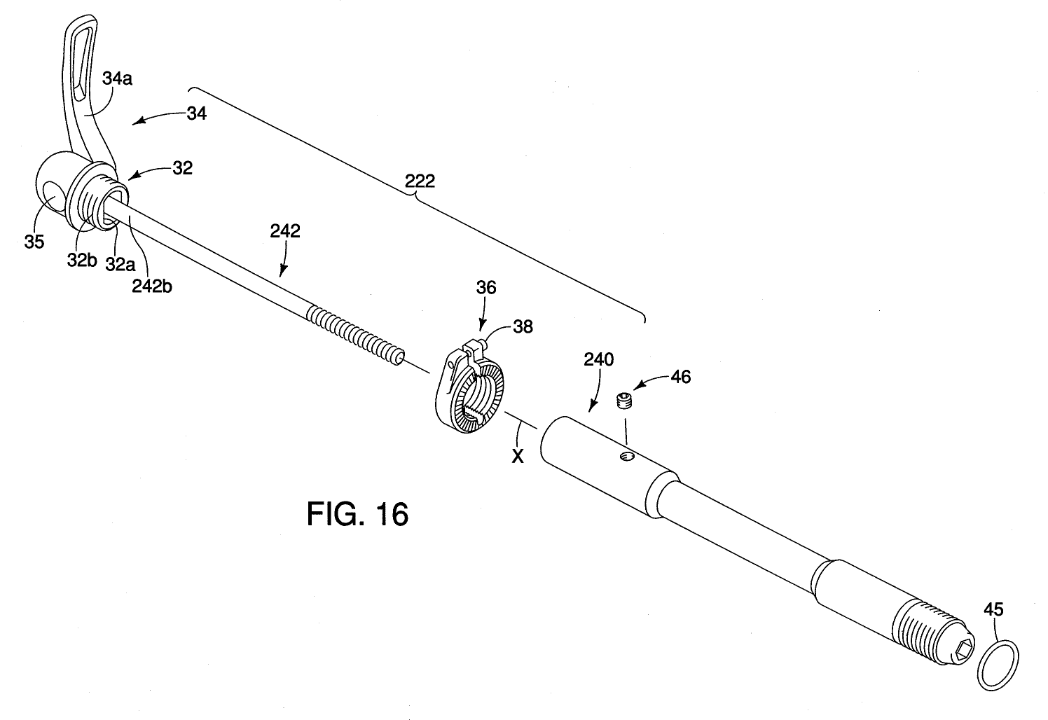

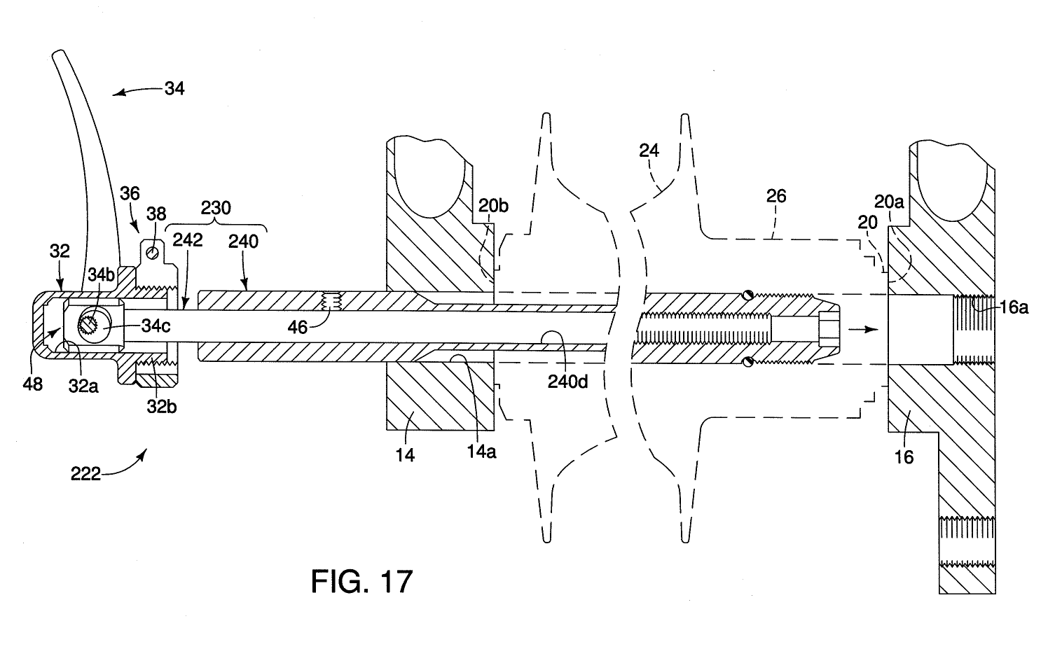

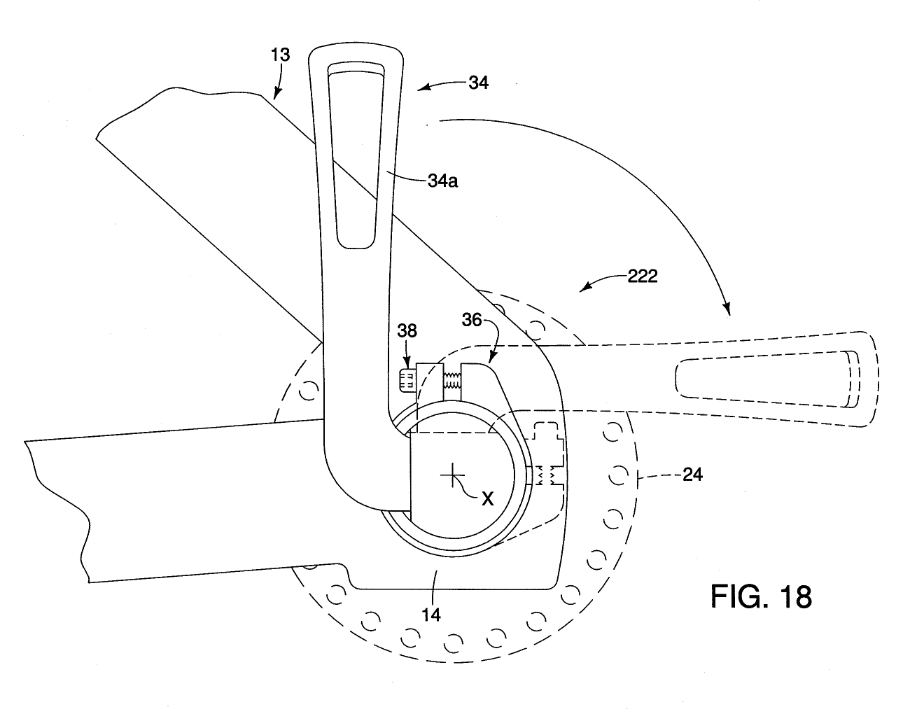

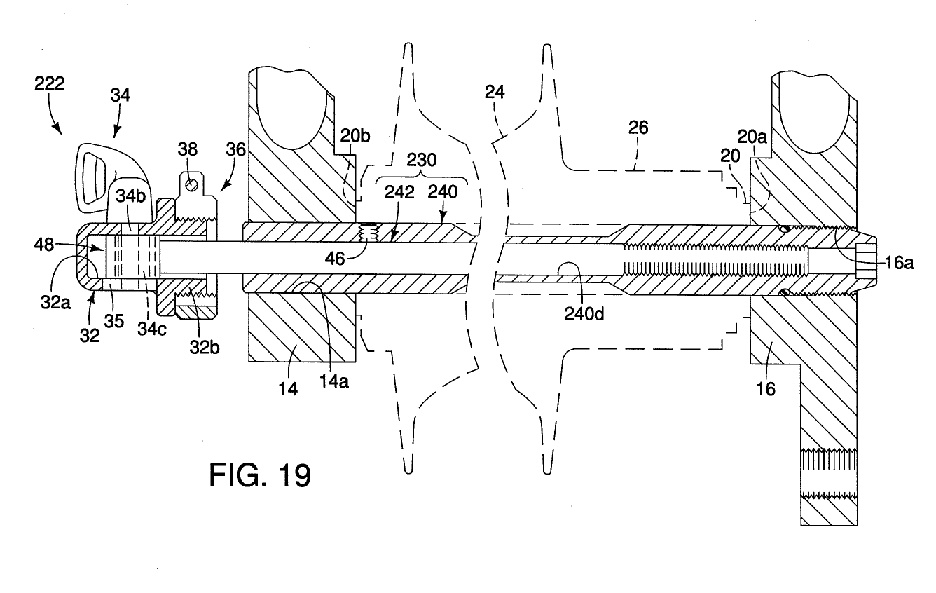

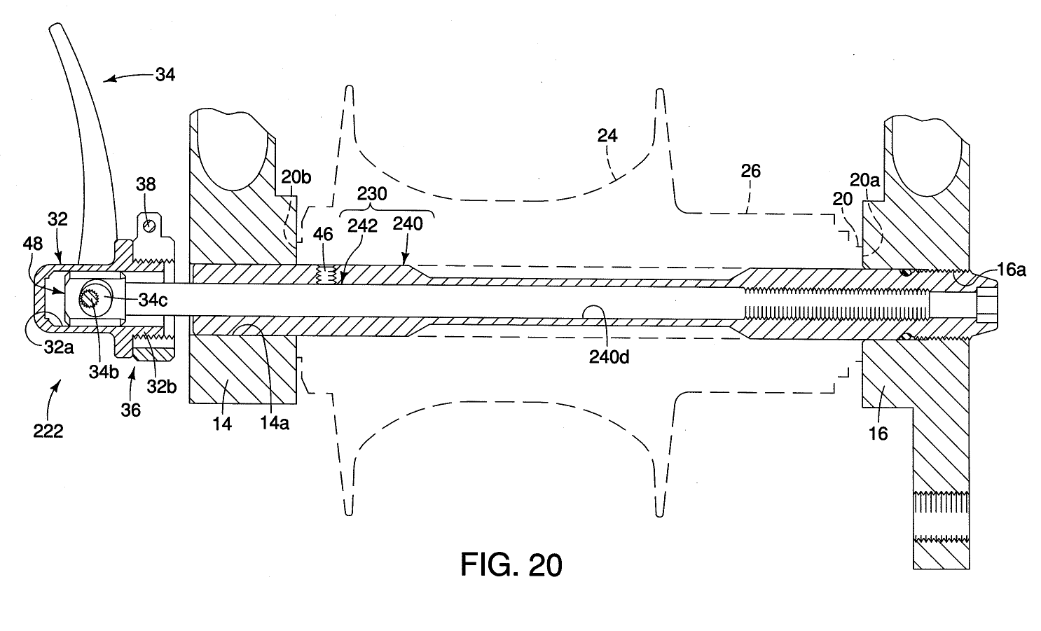

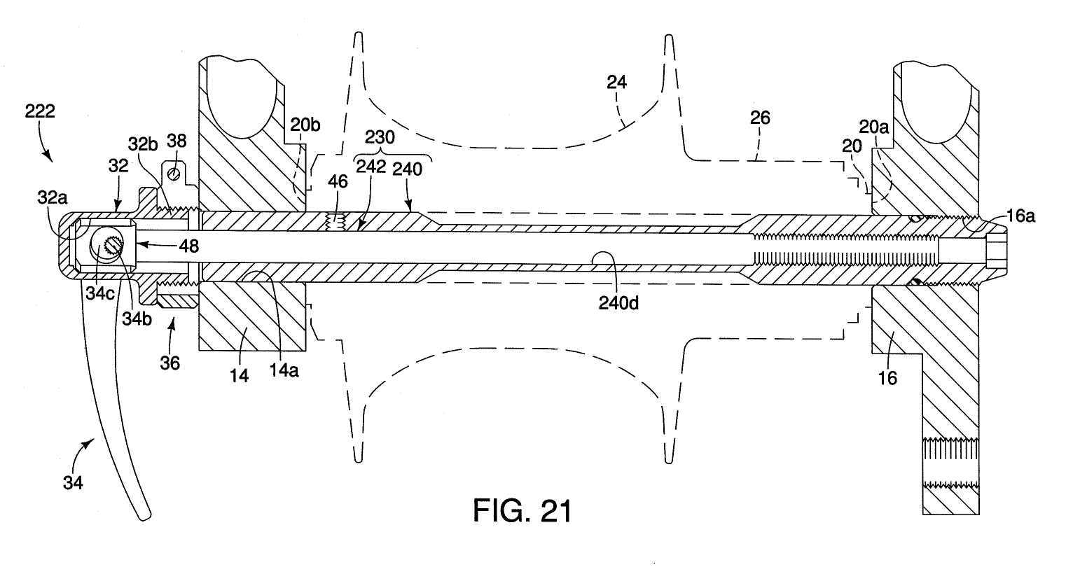

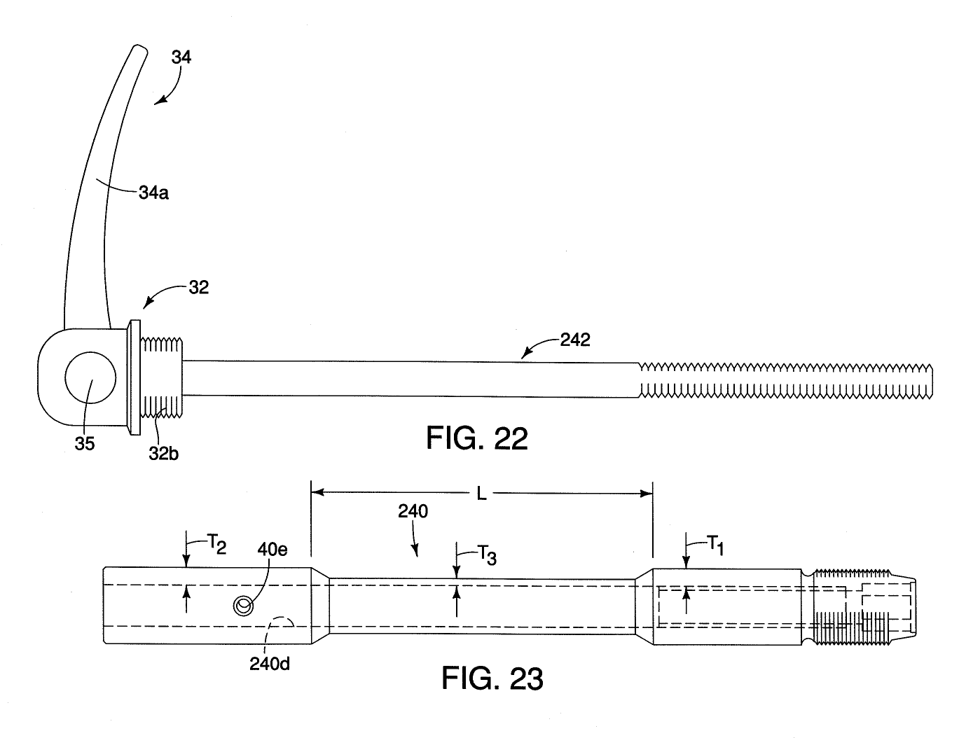

Referring now to FIGS. 15-23, a bicycle wheel securing structure or axle 222 having a modified shaft member 230 in accordance with a second embodiment of the present invention will now be explained. The wheel securing axle 222 of this second embodiment is identical to the wheel securing axle 22 of the first embodiment, except for the shaft member 230. Accordingly, this second embodiment will not be discussed and/or illustrated in detail herein, except as related to the shaft member 230. However, it will be apparent to those skilled in the bicycle art from this disclosure that the descriptions and illustrations of the first embodiment also apply to this second embodiment, except as explained and/or illustrated herein. Moreover, it will be apparent to those skilled in the bicycle art from this disclosure that the wheel securing axle 222 is designed to replace the wheel securing axle 22 of the first embodiment to mount the unit including the main hub axle 20, the hub assembly 24 and the free wheel 26 to the frame mounting flanges 14 and 16 in the manner described above with respect to the first embodiment and as illustrated in FIGS. 1-14.

Parts of this second embodiment that are identical to parts of the first embodiment will be identified with same reference characters as the first embodiment for the sake of convenience. Parts of this second embodiment that are functionally identical (but not exactly identical) to parts of the first embodiment will be identified with the same reference characters but with “200” added thereto for the sake of convenience.

The shaft member 230 includes a modified outer axle 240 and a modified inner axle 242 that are attached together using a modified fixing structure to prevent axial removal of the inner axle 242 from the outer axle 240 and to prevent relative rotation between the inner axle 242 and the outer axle 240. Specifically, this embodiment uses a longer inner axle 242, and the outer axle 240 includes a modified through bore 240d configured and arranged to cooperate with the longer inner axle 242. More specifically, in this second embodiment, the through bore 240d has a threaded section 240h disposed at an opposite end of the outer axle than the threaded section 40h of the first embodiment. The inner axle 242 is axially longer than the first embodiment, and has a uniform diameter to mate with the slightly stepped bore 240d in a manner substantially identical to the first embodiment. Additionally, the threads of the inner axle 242 are located further from the head member 32 than a smooth engagement section or outer surface, which engages the set screw 46.

### Third Embodiment

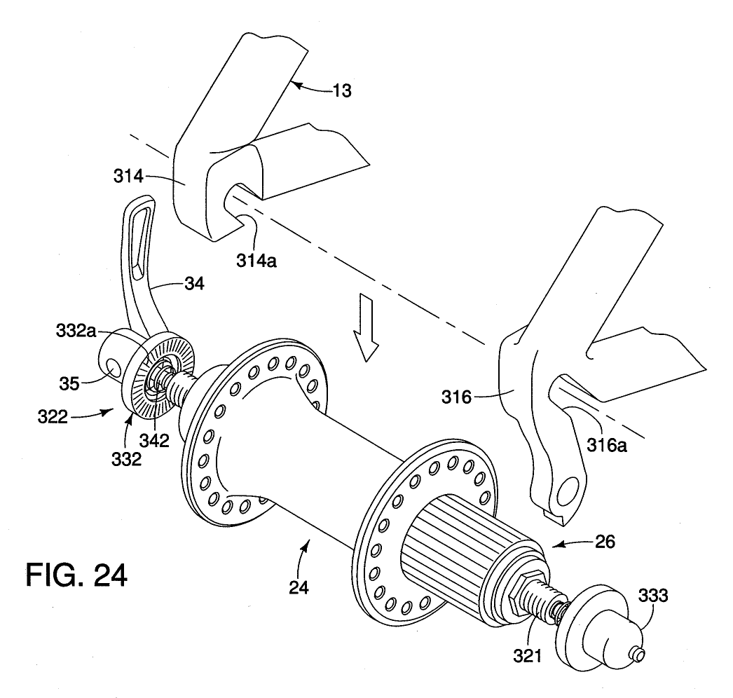

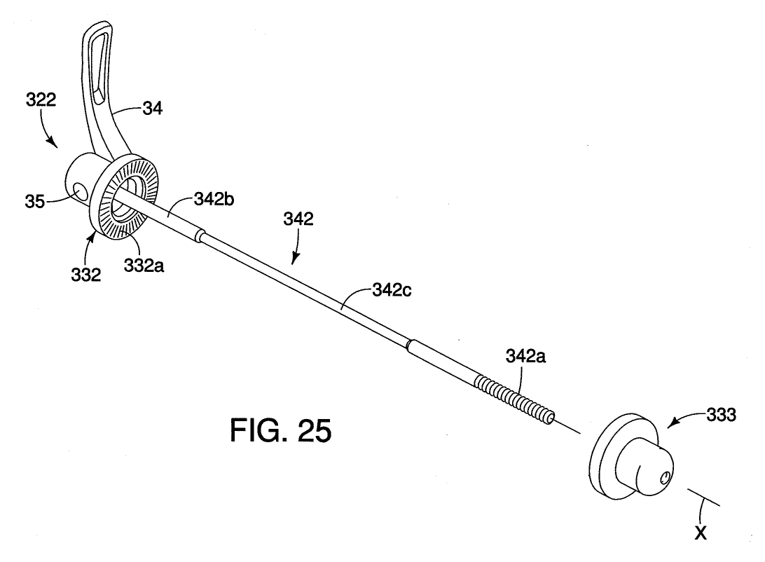

Referring now to FIGS. 24-25, a bicycle wheel securing structure or axle 322 having a modified shaft member in accordance with a third embodiment of the present invention will now be explained. In this embodiment, a modified inner axle 342 alone constitutes the modified shaft member. In other words, in this third embodiment, the outer axle 40 of the first embodiment has been eliminated such that the shaft member of the wheel securing structure 322 does not have a “double-axle” structure like the preceding embodiments. Additionally, a conventional hub main axle 321 is utilized in place of the main hub axle 20 of the preceding embodiments in order to accommodate the inner axle (shaft member) 342. The main hub axle 321 has nuts threaded on the external surface thereof to retain the main hub axle 321 with the other parts of the tubular hub structure in a conventional manner, and an inner diameter sized to receive the inner axle (shaft member) 342 therethrough. The ends of the main hub axle 321 project axially further than the main hub axle 20 so that they can be received in holes/slots of a bicycle frame. Thus, the hub assembly 24 and the free wheel 26 are rotatably supported on the main hub axle 321 via a bearing assembly and/or other conventional parts in a conventional manner.

The inner axle (shaft member) 342 has been constructed with a reduced radial thickness central portion 342c disposed between first and second end portions 342a and 342b in accordance with the present invention. The first end portion 342a is externally threaded such that a conventional wheel securing nut 333 can be attached to the first end portion 342a after inserting the inner axle 342 through the main axle 320. Finally, the adjustment member 36 of the first embodiment has been eliminated, and a modified head member 332 has been provided that includes an abutment surface 332a rather than the threaded tubular section 32b of the first embodiment.

With the arrangement of this embodiment, the inner axle (shaft member) 342 can remain coupled to the tubular hub structure during attachment to and removal from conventional frames having mounting flanges 314 and 316 with open ended slots 314a and 316a, respectively. In view of the similarity between this embodiment and the first embodiment, this third embodiment will not be discussed and/or illustrated in detail herein. However, it will be apparent to those skilled in the bicycle art from this disclosure that the descriptions and illustrations of the first embodiment also apply to this third embodiment, except as explained and/or illustrated herein.

Parts of this third embodiment that are identical to parts of the first embodiment will be identified with same reference characters as the first embodiment for the sake of convenience. Parts of this third embodiment that are functionally identical (but not exactly identical) to parts of the first embodiment will be identified with the same reference characters but with “300” added thereto for the sake of convenience.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle wheel securing structure comprising:
a shaft member having a first end portion, a second end portion and a central portion disposed between the first and second end portions with a center axis extending between the first and second end portions;
a head member disposed on the second end portion of the shaft member;
a lever member operatively mounted to move the shaft member in an axial direction relative to the head member in response to movement of the lever member,
the central portion of the shaft member having a radial thickness smaller than the first and second end portions.

2. The bicycle wheel securing structure according to claim 1, wherein
the first and second end portions of the shaft member have first and second non-threaded sections, respectively, and the central portion of the shaft member has a radial thickness smaller than the first and second non-threaded sections.

3. The bicycle wheel securing structure according to claim 1, wherein
the central portion of the shaft member has a maximum axial length that is at least 25% of an overall axial length of the shaft member.

4. The bicycle wheel securing structure according to claim 3, wherein
the maximum axial length of central portion is at least 33% the overall axial length of the shaft member.

5. The bicycle wheel securing structure according to claim 1, wherein
the shaft member has a smaller external diameter along the central portion than along the first and second end portions.

6. The bicycle wheel securing structure according to claim 1, wherein
the first end portion of the shaft member includes a threaded section.

7. The bicycle wheel securing structure according to claim 1, further comprising
a tubular hub structure having the shaft member extending therethrough, the tubular hub structure being configured to be secured axially between two parts of a bicycle fork.

8. The bicycle wheel securing structure according to claim 7, wherein
the central portion of the shaft member has a maximum axial length that is at least 50% of an overall axial length of the tubular hub structure.

9. The bicycle wheel securing structure according to claim 7, wherein
the tubular hub structure includes first and second end parts having first and second oppositely facing end surfaces, respectively, and
the first and second end portions axially overlap the first and second end surfaces to radially support the first and second end parts.

10. The bicycle wheel securing structure according to claim 1, wherein
the shaft member includes an outer axle and an inner axle at least partially disposed within an internal bore of the outer axle in an installed position, the head member being attached to an end of the inner axle extending out of the internal bore.

11. The bicycle wheel securing structure according to claim 10, wherein
the first end portion of the outer axle includes a threaded section.

12. The bicycle wheel securing structure according to claim 10, wherein
the shaft member has a smaller external diameter along the central portion than along the first and second end portions, the external diameter of the shaft member being measured along the outer axle.

13. The bicycle wheel securing structure according to claim 10, wherein
the internal bore of the outer axle is a through bore.

14. The bicycle wheel securing structure according to claim 10, wherein
the outer axle includes a first tubular portion, a second tubular portion and a central tubular portion disposed between the tubular first and second portions, and
the first and second tubular portions have first and second radial thicknesses that are at least twice a radial thickness of the central tubular portion.

15. The bicycle wheel securing structure according to claim 14, wherein
the shaft member has a smaller external diameter along the central portion than along the first and second end portions, the external diameter of the shaft member being measured along the outer axle.

16. The bicycle wheel securing structure according to claim 10, wherein
the shaft member includes a fixing structure disposed between the outer axle and the inner axle to releasably prevent axial removal of the inner axle from the internal bore when the inner axle is in the installed position.

17. The bicycle wheel securing structure according to claim 16, wherein
the fixing structure includes a threaded connection between the outer axle and the inner axle.

18. The bicycle wheel securing structure according to claim 10, wherein
the shaft member includes a fixing structure disposed between the outer axle and the inner axle to releasably prevent relative rotation of the inner axle within the internal bore when the inner axle is in the installed position.

19. The bicycle wheel securing structure according to claim 18, wherein
the fixing structure includes a set screw arranged in a transverse threaded bore of the outer axle, the transverse threaded bore extending between an external surface of the outer axle and the internal bore such that the set screw is releaseably engageable with the inner axle.

20. The bicycle wheel securing structure according to claim 18, wherein
the fixing structure includes a threaded connection between the outer axle and the inner axle.

21. The bicycle wheel securing structure according to claim 1, wherein
the shaft member includes a first tubular portion, a second tubular portion and a central tubular portion disposed between the tubular first and second portions, and
the first and second tubular portions have first and second radial thicknesses that are at least twice a radial thickness of the central tubular portion.

22. The bicycle wheel securing structure according to claim 21, wherein
the shaft member has a smaller external diameter along the central portion than along the first and second end portions.
